(19) United States
(12) Patent Application Publication
(10) Pub. No.: US 2003/0225558 A1
(43) Pub. Date: Dec. 4, 2003

(54) Logic simulation method for information handling system incorporated with memory macro

(75) Inventors: Toshihiro Ueda, Kanagawa (JP); Hiroshi Kikuchi, Kanagawa (JP)

Correspondence Address: FOLEY AND LARDNER, SUITE 500, 3000 K STREET NW, WASHINGTON, DC, 20007, US

(73) Assignee: NEC Electronics Corporation

(21) Appl. No.: 10/442,107

(22) Filed: May 21, 2003

(30) Foreign Application Priority Data
May 28, 2002 (JP) 2002-153603

(51) Int. Cl. G06F 17/50

(52) U.S. Cl. 703/15

(57) ABSTRACT

A plurality of data code files including addresses and data to be written to the addresses are prepared. Next, a simulation model of a memory macro (memory macro model) is set to write mode. Then, an address value and data value are extracted from a verification pattern at a write-in operation in the first clock cycle after the write mode has been set. A necessary data code file is selected from the plurality of data code files based on the extracted search key. Finally, data are written at once to the simulation model of the memory macro according to contents of the selected data code file.

### BACKGROUND OF THE INVENTION

1. Field of the Invention

The present invention relates to a method for performing logic simulation on an information handling system/circuit and, more particularly, to a logic simulation method for such an data processing circuit that has as a part thereof a memory macro which is registered in a library as a memory component.

2. Related Background Art

In the course of developing and designing an information handling circuit or data processing circuit, logic simulation is executed in order to simulate logic operations/functions of such circuit. Recent data processing circuit has been required to attain multiple functions more and more. Some circuit includes a memory component, wherein data to be processed are temporarily stored therein and then readout therefrom to a processing unit to be subjected to a data processing operation. In order to simulate such circuit, a memory macro is provided as a memory component and registered in a library. In addition, the data processing unit is realized by combining a plurality of logic cells and/or macros that are also registered in the libirary.

FIG. 17 illustrates a simulation model for such data processing circuit including a memory macro. The simulation model including the memory macro 1, which will be referred to hereinafter as a memory macro model. This model 1 has a clock input terminal CLK, mode switching terminal WEB, address input terminal A, data input terminal DI, and data output terminal DO. The simulation model used here includes a memory area of 32 words by 4 bits. The operation logic shown in FIG. 18 is defined for the memory macro model 1. In the operation logic, “DM” means a data value in a memory cell in the memory macro model 1, and “Hold” means no value change in an input event. The data stored in the memory macro model 1 are read out therefrom and supplied to a next logic stage that is indicated as “system” in FIG. 17.

Logic simulation with the memory macro model 1 will be explained hereinafter with reference to the flowchart shown in FIG. 19 and the timing chart shown in FIG. 20. In this simulation, the data input terminal DI, address input terminal A, clock input terminal CLK, and the mode switching terminal WEB receive the signals shown in reference symbols (a), (b), (c), and (d) in FIG. 20, respectively. A signal pattern sent to the clock input terminal CLK in every clock cycle is called a verification pattern.

Logic Simulation with Memory Macro Model

First, an input event is detected at Step 901. The input event refers to a logic level change in a clock signal to the clock input terminal CLK and a mode switching signal to the mode switching terminal WEB, and the like.

When a mode switching signal to the mode switching terminal WEB changes from level 1 to 0 at the time point of T21 in FIG. 20(d), the memory macro model 1 enters a write mode allowing data write-in. Then, when a clock signal to the clock input terminal CLK changes from level 0 to 1 at T22 (YES at Step 902), the value of the mode switching signal to the mode switching terminal WEB is checked at the same time (Step 903).

Since the mode switching signal to the mode switching terminal WEB here is at level 0, the process proceeds to Step 904 to extract an address value from the signal value given to the address input terminal A. The process then proceeds to Step 905 to extract a data value from the signal value given to the data input terminal DI. The data are then written to the memory macro model 1 (Step 906). The data readout at Step 905 are thus written to the address extracted at Step 904.

During the write mode between T21 and T23, the data writing to the memory macro model 1 is repeated every time the clock signal changes from level 0 to 1. Data are thereby written, one by one, to 32 addresses of addresses 0 to 31.

Data Readout

When the mode switching signal to the mode switching terminal WEB changes from level 0 to 1 at T23 in FIG. 20, the memory macro model 1 enters a read mode allowing data readout. When, after the mode change, the clock signal to the clock input terminal CLK changes from level 0 to 1 at T24 (YES at Step 902), the value of the mode switching signal to the mode switching terminal WEB is checked at the same time (Step 903).

Since the mode switching signal here is at level 1, the process proceeds to Step 907 to extract an address value from the signal value given to the address input terminal A. The process further proceeds to Step 908 to read out the data stored in the address from the memory macro model 1, and output the data to the data output terminal DO (Step 908).

During the read mode between T23 and T25, the data readout from the memory macro model 1 is repeated at every change of the clock signal from level 0 to 1. Data are thereby read out, one by one, from 32 addresses of addresses 0 to 31. The date thus read out in sequence from the memory macro model 1 are supplied to the next stage “system” as logic simulation data pattern.

In the prior art as discussed above, the inventors of the present invention has directed their attention to the data writing operation into the memory macro model 1. Specifically, The above conventional method for logic simulation with a memory macro model requires as many verification patterns as the addresses (32 clocks) in the write mode between T21 and T23; accordingly, the processes of Steps 902 to 906 should be repeated 32 times. Further verification requires repeating the same processes during the write mode between T25 and T26 whenever the logic simulation data pattern to be supplied to the next circuit “system” is changed. The logic simulation therefore takes a long execution time. It also takes a long time for creating verification pattern.

The time required for logic simulation execution and verification pattern creation depends on the size of a memory macro included in a designed circuit, and the problem is more severe in a LSI device provided with larger memory macro. Especially in a whole system verification following module-by-module verification in a hierarchically designed system, even if verification of a memory macro has completed, memory data have to be written into a memory macro model repeatedly, similarly to an actual LSI chip. It causes a longer logic simulation execution time and longer verification pattern creation time.

As a solution to the above problems, one may consider to add a virtual terminal or internal node to a memory macro model to allow batch writing of memory data by processing events occurring there. However, providing a virtual terminal necessitates creating circuit connection data not corresponding to a LSI device circuit and inputting a verification pattern to the virtual terminal. Also, providing an internal node necessitates setting condition for verification pattern input to enable event processing therein, and complicated operation is required for creating verification patterns.

### SUMMARY OF THE INVENTION

An object of the present invention is thus to provide a logic simulation method and system which saves time for logic simulation execution and verification pattern creation without a virtual terminal or internal node.

A logic simulation method according to one aspect of the present invention is applied to such a data handling circuit that has a memory macro and a data processing unit coupled to the memory macro to receive and perform a data processing operation on the data read out of the memory macro and is characterized by including at least three steps:

the first step is to write a plurality data into the meory macro at one time;

the second step is to read out the data from the memory macro in sequence (one by one); and

the third step is to supply the data processing unit (that is logic cells or macros registered in the library) with the data read out in sequence from the memory macro.

According to another aspect of the present invention, there is provided a logic simulation method that prepares a plurality of data code files including addresses and data to be written to the addresses, sets the simulation model of the memory macro to a data write mode with supplying a search key, retrieves, from the plurality of data code files, a necessary data code file identified by the search key, and writes data to the simulation model of the memory macro all at once according to contents of the retrieved data code file.

With above construction, a search key (for example, an address and data or a verification pattern number) is extracted from a verification pattern at write-in operation in the first clock cycle after a simulation model of memory macro (memory macro model) enters the data write mode (write mode), a necessary data code file specified by the extracted search key is retrieved from a plurality of data code files, and data are written to the memory macro model all at once in accordance with contents of the retrieved data code file.

Therefore, data are written to the memory macro model all at once according to contents (addresses and data to be written to the addresses) of a necessary data code file in the first clock cycle after the memory macro model enters data write mode. The data code file does not necessarily include data for all the addresses of the memory macro, but can include data for necessary addresses only. If the file has data for all the addresses, the data for all the addresses are written to the memory macro model all at once in one clock cycle. If, on the other hand, the file has data only for necessary addresses, the data for the necessary addresses are written in the same manner.

### BRIEF DESCRIPTION OF THE DRAWINGS

The above and other objects, features and advantages of the present invention will become more fully understood from the detailed description given hereinbelow and the accompanying drawings which are given by way of illustration only, and thus are not to be considered as limiting the present invention.

FIG. 1 shows a substantial part of a logic simulation system used for the logic simulation method according to the present invention.

FIGS. 2A and 2B show examples of a data code file used for the logic simulation system.

FIG. 3 is a flowchart to explain logic simulation with a memory macro model.

FIG. 4 is a timing chart to explain logic simulation with a memory macro model.

FIG. 5 shows an example of conversion of temperatures to digital signals by a temperature sensor macro.

FIG. 6 shows a simulation model of the temperature sensor macro.

FIG. 7 shows a theoretical simulation model of the temperature sensor macro.

FIG. 8 is a flowchart to explain logic simulation with a memory macro in the theoretical simulation model of the temperature sensor macro.

FIG. 9 is a timing chart to explain logic simulation with a memory macro in the theoretical simulation model of the temperature sensor macro.

FIGS. 10A and 11B show examples of a data code file used for logic simulation with a memory macro in the theoretical simulation model of the temperature sensor macro.

FIG. 11 shows a simulation model of an A/D converter macro.

FIG. 12 shows a theoretical simulation model of the A/D converter macro.

FIGS. 13A and 13B show examples of a data code file used for logic simulation with a memory macro model in the theoretical simulation model of the A/D converter macro.

FIG. 14A and 14B show examples of a sampling waveform in creating a data code file to be used for logic simulation with a memory macro model in the theoretical simulation model of the A/D converter macro.

FIG. 15 is a flowchart to explain the logic simulation with the memory macro model in the theoretical simulation model of the A/D converter macro.

FIG. 16 is a timing chart to explain the logic simulation with the memory macro model in the theoretical simulation model of the A/D converter macro.

FIG. 17 shows a simulation model including a memory macro model.

FIG. 18 shows operation logic of a memory macro model.

FIG. 19 is a flowchart to explain conventional logic simulation with a memory macro model.

FIG. 20 is a timing chart to explain conventional logic simulation with a memory macro model.

### DESCRIPTION OF THE PREFERRED EMBODIMENTS

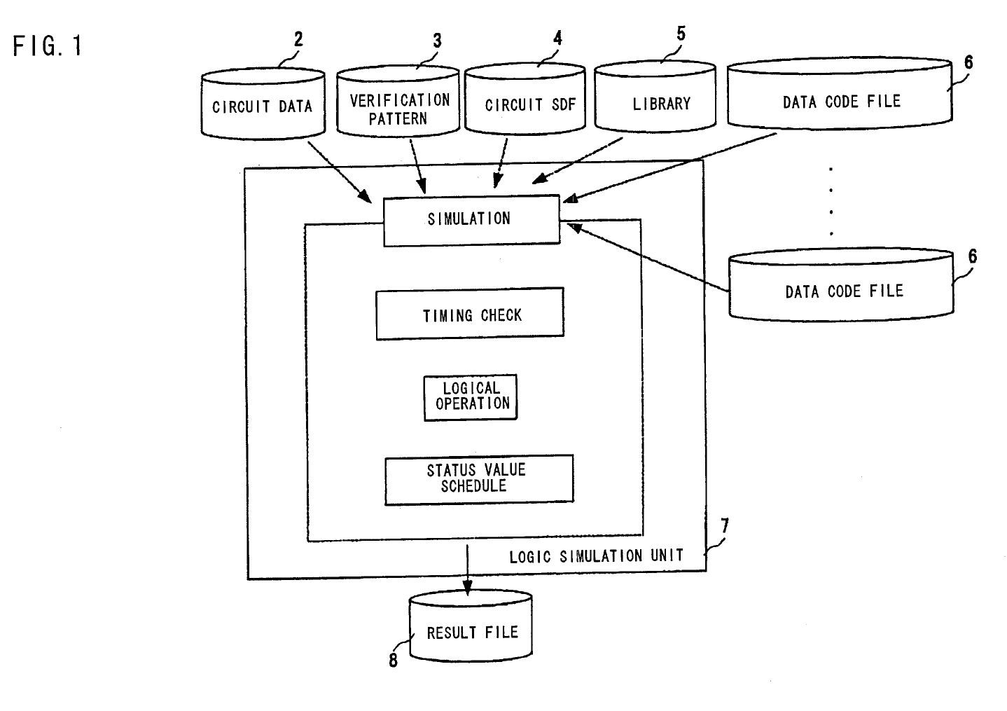

In the following, the present invention will be explained in detail with reference to the accompanying drawings. FIG. 1 shows a substantial part of a logic simulation system used for the logic simulation method according to the present invention.

In FIG. 1, reference numeral 2 designates a circuit data file storing information on a designed circuit connection, 3 a verification pattern file storing a verification pattern which is input data for verifying circuit data operation, 4 a delay timing information file (circuit SDF file) storing internal delay value of each logic cell included in the circuit data, timing spec, and wire delay value between logic cells, 5 a library storing a simulation model including the memory macro of a designed circuit and the operation logic of each simulation model. The library 5 further stores a plurality of logic cells and/or macros that are used to simulate a data processing unit which is coupled to the memory macro as a subsequent stage to receive and perform a data processing operation on the data read out of the memory macro.

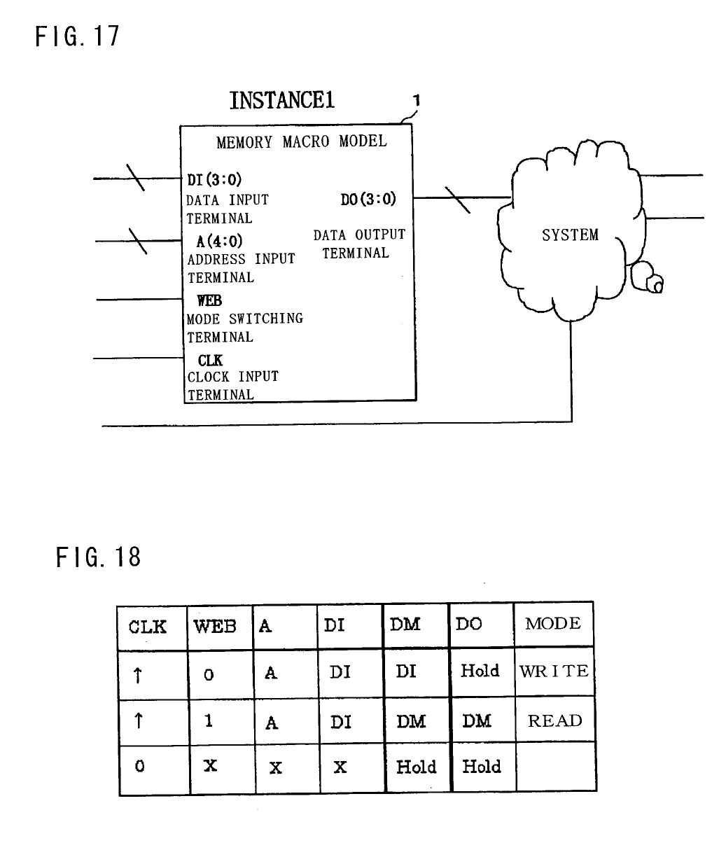

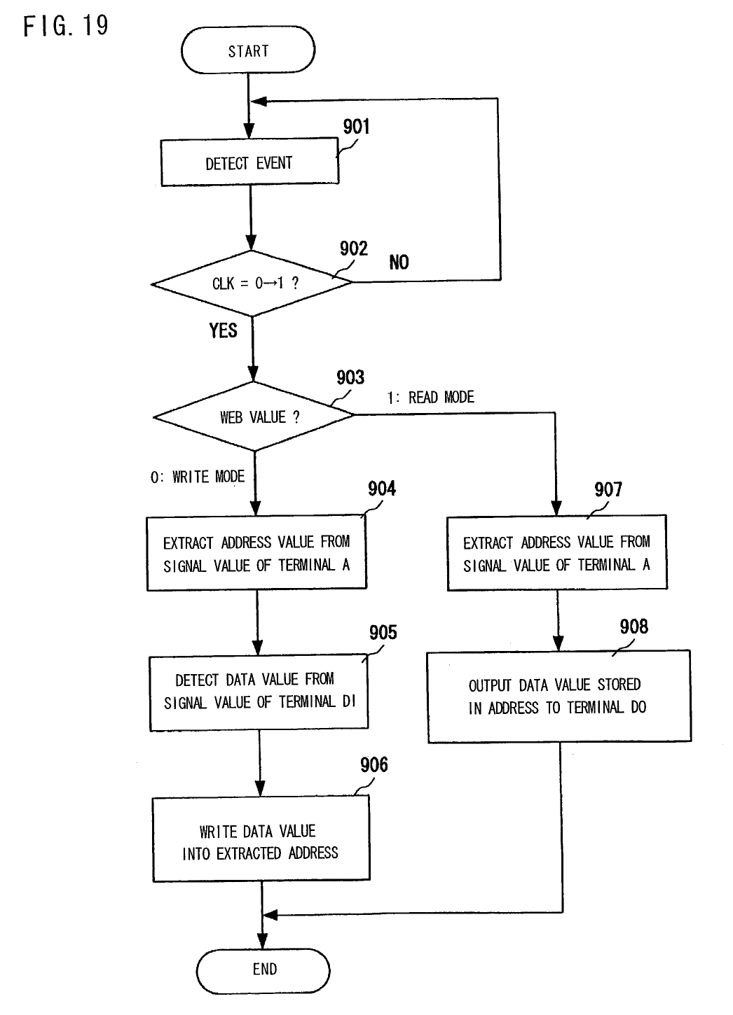

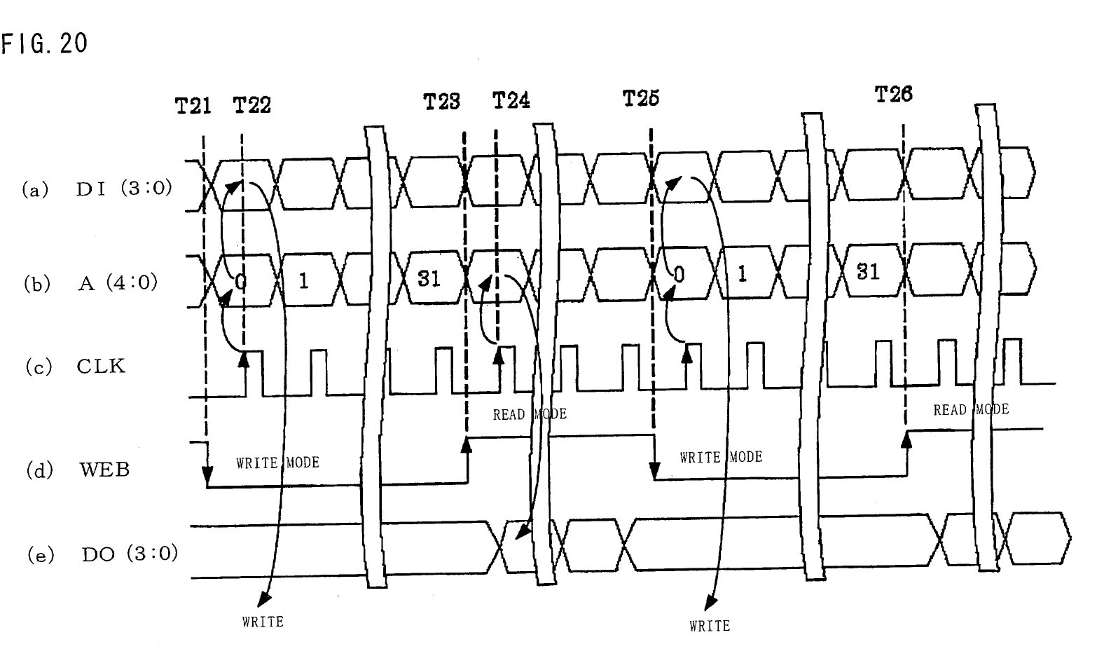

The library 5 stores the memory macro model 1 shown in FIG. 17 and the operation logic defined for the memory macro model 1, shown in FIG. 18. Reference numeral 6 designates a plurality of data code files including addresses and data to be written to the addresses, and 7 designates a logic simulation unit (logic simulator) carrying out logic simulation process.

The logic simulation unit 7 mainly performs “timing check”, “logical operation”, and “status value schedule”. These processes are carried out for each of verification patterns. The logic simulation processing is followed by output of a logic simulation result file 8 in which information on timing error occurred during simulation execution, logical operation value of every verification pattern, and so on.

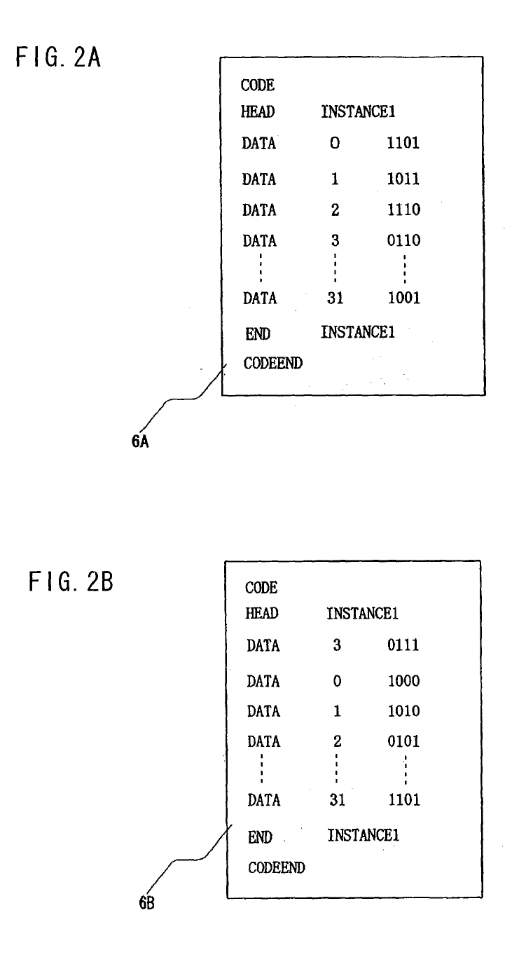

FIGS. 2A and 2B show examples of the data code file 6. The present embodiment uses the data code files 6A and 6B, for example, as the data code file 6. In the data code files 6A and 6B, an instance name of the memory macro model for which the data code file is used is written on the HEAD line, and an address value (the first argument) and a data value (the second argument) on the DATA line. The data code files 6A and 6B are stored in given directories, which are to be specified by an environment variable at the logic simulation execution, to pick up the necessary data code file identified by a search key which will be detailed later.

Logic Simulation with Memory Macro Model

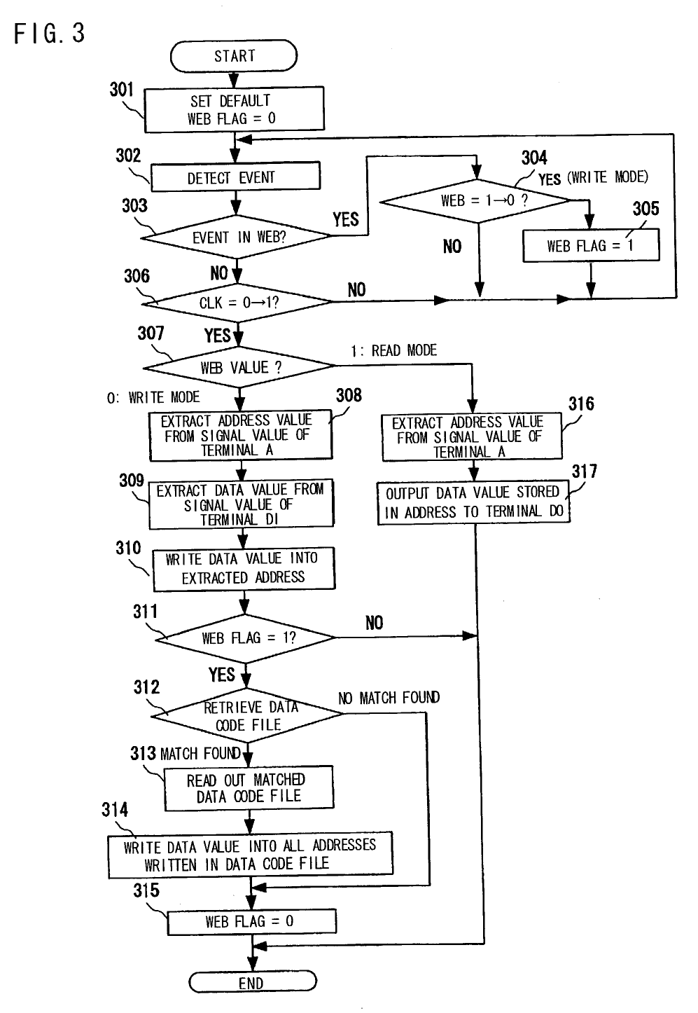

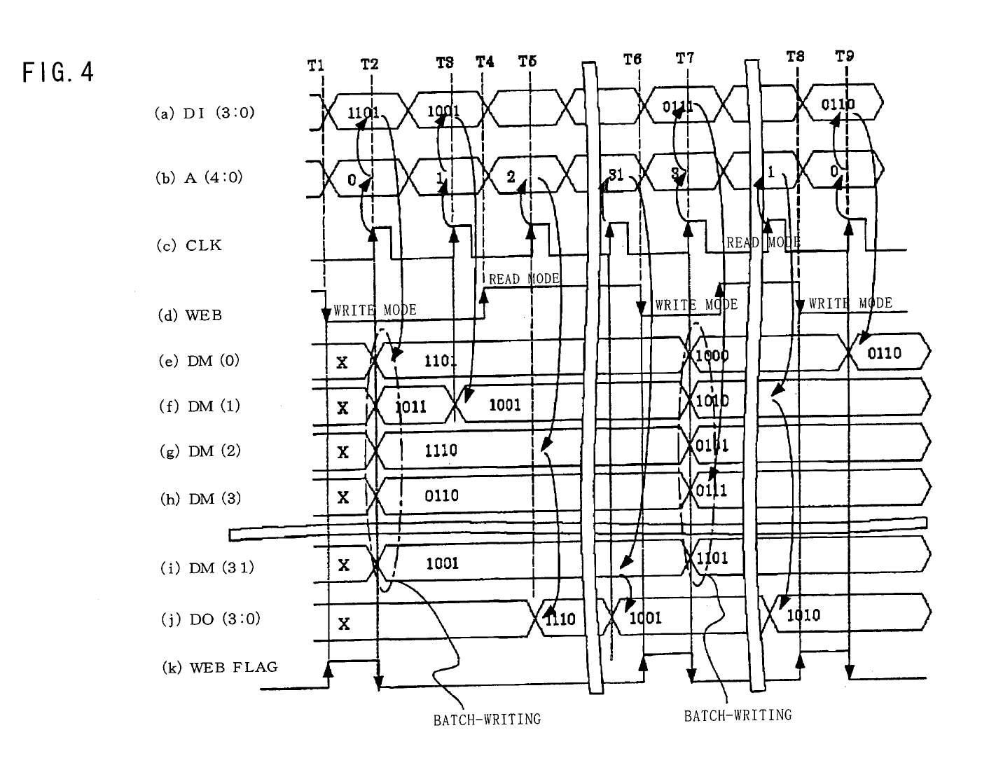

The logic simulation with the memory macro model 1 registered in the library 5 will be explained hereinafter with reference to the flowchart shown in FIG. 3 and the timing chart shown in FIG. 4. In this simulation, the signals shown in reference symbols (a), (b), (c), and (d) in FIG. 4 are sent to the data input terminal DI, address input terminal A, clock input terminal CLK, and the mode switching terminal WEB, respectively.

At the start of logic simulation with the memory macro model 1, the logic simulation unit 7 initializes the WEB flag to “0” (Step 301). The WEB flag is initialized only at the beginning of the logic simulation with the memory macro model 1, and not at logical operations performed repeatedly during the logic simulation execution. Although not shown, the WEB flag is provided inside the logic simulator 7. The process therefore performs the WEB flag initialization only at the beginning of the logic simulation, and skips Step 301 to proceed to Step 302 from the subsequent logic operations.

Batch-Writing of Data

The logic simulation unit 7 detects an input event at Step 302. When a mode switching signal to the mode switching terminal WEB changes from level 1 to 0 at T1 in FIG. 4(d), the memory macro model 1 enters write mode. The change in the mode switching signal from level 1 to 0 is detected as an input event at Step 302.

The logic simulation unit 7 confirms that the input event is at the mode switching terminal WEB (YES at Step 303), and that it is a change from level 1 to 0 (YES at Step 304). Then, the unit 7 sets a WEB flag to 1 (Step 305; T1 in FIG. 4(k)), then the process returns to Step 302.

Next, when a clock signal to the clock input terminal CLK changes from level 0 to 1 at T2 (YES at Step 306), the value of the mode switching signal to the mode switching terminal WEB is checked at the same time (Step 307).

Since the mode switching signal to the mode switching terminal WEB is at level 0, the process proceeds to Step 308 to extract an address value from the signal value given to the address input terminal A. The address value 0 is extracted in this case. The process then proceeds to Step 309 to extract a data value from the signal value given to the data input terminal DI. The data value 1101 is extracted in this case. The data are then written to the memory macro model 1 (Step 310), that is, the data read out at Step 309 are written to the address extracted at Step 308.

Then, the logic simulation unit 7 checks the WEB flag value (Step 311). Since the WEB flag value is set to “1” here, the process proceeds to Step 312 to search a data code file. In the data code file search, the logic simulation unit 7 selects from directories the data code file in which an instance name written on the HEAD line thereof matches the instance name of the memory macro model 1, and the first address value (the first argument) and data value (the second argument) written on the DATA line thereof match the address value and the data value extracted at Steps 308 and 309

Since the instance name of the memory macro model 1 is “INSTANCE 1”, the address value extracted at Step 308 is “0”, and the data value extracted at Step 309 is “1101”, the data code file 6A shown in FIG. 2A is selected. Then, the logic simulation unit 7 reads out the selected data code file 6A (Step 313), and writes data at once to the memory macro model 1, according to contents of the data code file 6A which are an address and data to be written to the address (Step 314).

Because the data code file 6A shown in FIG. 2A has data for all the addresses of the memory macro model 1, the data are written at once to all the address of the memory macro model 1 in the first clock cycle after the memory macro model 1 has entered the write mode. The data in memory cells in the memory macro model 1 corresponding to each address are rewritten into the values shown in FIG. 4(e) to (i). “$readmemh task” and the like may be used in verilog-HDL for writing data at once.

After writing the data at once at Step 314, the logic simulation unit 7 sets the WEB flag back to “0” (Step 315; T2 in FIG. 4(k)) for the subsequent logical operation.

Since no change occurs to the mode switching signal to the mode switching terminal WEB after that, that is, no event is input to the mode switching terminal WEB, the WEB flag remains “0” indicating the write mode and never changes to “1” after the second clock cycle. Therefore, even if event input occurs at the clock input terminal CLK, Step 311 results in NO and the process does not proceed to Step 312, thus the batch data writing to the memory macro model 1 is not carried out.

In this case, the clock signal to the clock input terminal CLK changes from level 0 to 1 at the time point of T3. With the mode switching terminal WEB value 0, the write mode operation remains active to proceed through Step 306 and 307 to Steps 308, 309, and 310. Step 308 extracts the address value “1”, Step 309 extracts the data value “1001”, and Step 310 writes the data “1001” to the address “1”. Since the WEB flag is set to 0 by the logical operation at T2, the Step 311 determines that the process does not proceed to Step 312.

After the second clock cycle, and in the first clock cycle when no match is found in the data code files stored in directories or in the write mode, Step 312 results in NO MATCH FOUND. Therefore, batch data writing to the memory macro model 1 is not carried out, and only the data extracted at Step 309 is written to the address extracted at Step 308.

Data Readout

When the mode switching signal to the mode switching terminal WEB changes from level 0 to 1 at the time point T4 shown in FIG. 4(d), the memory macro model 1 turns to the read mode. Step 302 detects the change in the mode switching signal from level 0 to 1 as an input event.

Confirming that the input event has occurred at the mode switching terminal WEB (YES at Step 303), the logic simulation unit 7 checks if the event is a change from level 1 to 0 (Step 304). Since the change is from 0 to 1 here, the process does not proceed to Step 305 but returns to Step 302 with the WEB flag remaining 0.

Then, when a clock signal to the clock input terminal CLK changes from level 0 to 1 at T5 (YES at Step 306), the value of the mode switching signal to the mode switching terminal WEB is checked at the same time (Step 307)

Since the mode switching signal here is at level 1, the process proceeds to Step 316 to extract an address value from the signal value given to the address input terminal A. The address value “2” is extracted in this case. The process further proceeds to Step 317 to read out the data value “1110” stored in the extracted address “2” from the memory macro model 1, and output the data to the data output terminal DO (Step 317).

During the read mode between T4 and T6, the data readout from the memory macro model 1 is repeated at every change of the clock signal from level 0 to 1. The data thus read out in sequence from the memory macro 1 are supplied under the control of the logic simulator 7 to logic cells and/or macros, which are also registered in the library 5, to simulate the data processing unit coupled to the memory macro.

Since the mode switching terminal WEB changes from level 1 to 0 at T6, the process proceeds through YES at Steps 303 and 304 to Step 305 to set the WEB flag “1”. Then, when an event change occurs at the clock input terminal CLK at T7, the address value “3” and the data value “0111” are extracted from the verification pattern (Steps 308 and 309), and the data value is then written to the memory macro model 1 (Step 310).

Confirming the WEB flag value is set to 1 (YES at Step 311), the logic simulation unit 7 searches a data code file (Step 312). In this case, with the first address value “0” written on DATA line, the data code file 6A shown in FIG. 2A has no match. A match is found in the first address value and data value on the DATA line in the data code file 6B shown in FIG. 2B; therefore, data are written to the memory macro model 1 at once, according to contents of the data code file 6B which are addresses and data to be written to the addresses (Step 314). After that, the WEB flag is set back to 0 (Step 315; T7 in FIG. 4(k)) for the subsequent logical operation.

At the time point T8, the WEB flag is set to “1” as is the same with T1 and T6 (Step 305), and the write mode operation begins when an event change occurs at the clock input terminal CLK at T9. The address value “0” and the data value “0110” are extracted at Steps 308 and 309 in this case, and the value is written to the memory macro model 1 at Step 310.

With the WEB flag “1”, the process proceeds from Step 311 to Step 312 to search a data code file. The data code file 6A shown in FIG. 2A has a match for the address value, but no match for the data value. Neither the address value nor the data value matches any in the data code file 6B shown in FIG. 2B. Given this result, the logic simulation unit 7 concludes that there is no necessary data code file for batch writing (NO MATCH FOUND at Step 312), and do not carry out batch data writing to the memory macro model 1. The WEB flag is then set back to “0” (Step 315; T9 in FIG. 4(k)) for the following logical operation.

As explained in the foregoing, while the conventional method requires 32 verification patterns to write data to all addresses of a memory macro model, the present invention needs only one verification pattern for all data writing, which is attained by means of batch writing. In addition, though the greater number of words requires the more verification patterns for data writing in the conventional method, one verification pattern allows all data writing regardless of a memory size in the present invention

Further, the present embodiment allows easy user control of data code file setting to determine whether data are to be written to all addresses or to selected addresses only. If data are given for all the addresses of a memory macro model, the data for all the addresses are written to the memory macro model at once. If, on the other hand, data are given only for necessary addresses, the data for the necessary addresses are written.

Besides, a user can select between batch writing and normal writing (data writing as LSI device function such as write mode, by input to an address terminal and data terminal). The selection is possible by changing data code file setting between use and non-use.

Further, all needed for the present embodiment is adding a data code file to a simulation system. No virtual terminal or internal node is required, and no complicated event is required in a verification pattern. Therefore, logic simulation execution time and time for verification pattern creation are saved, which results in significant reduction of the duration of circuit design.

Second Embodiment

The second embodiment explains a case of simulating a temperature sensor macro.

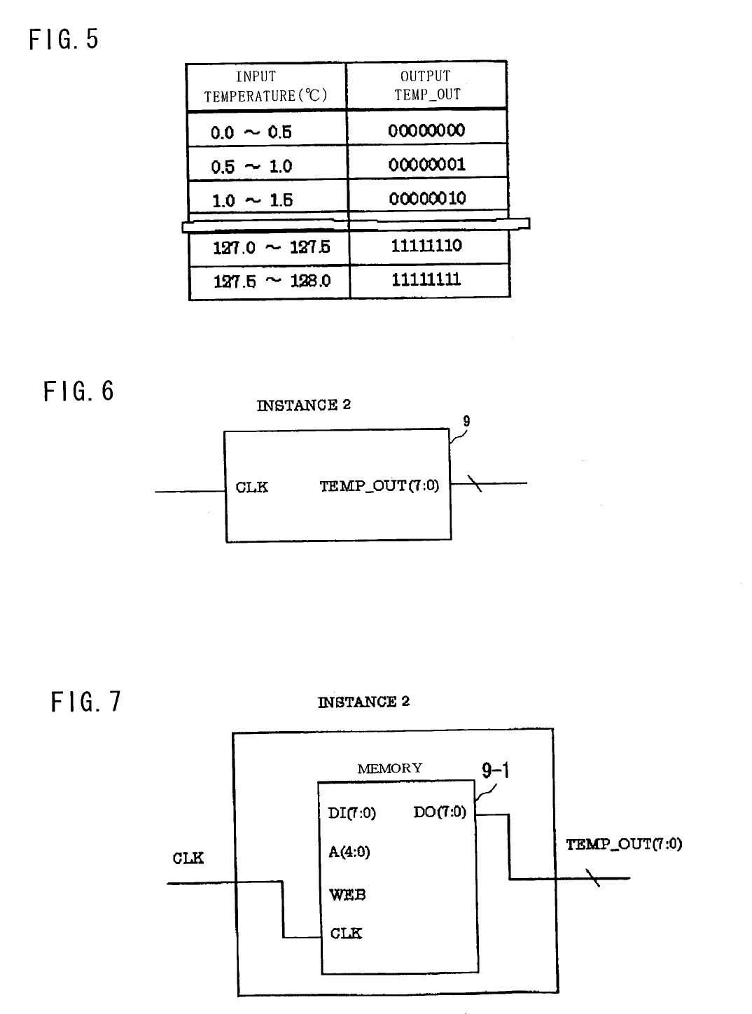

Analog signals, such as a temperature to voltage signal, are input to the temperature sensor macro, and the input signals are converted to digital signals for output. The temperature sensor macro thus converts a detected temperature to a digital signal and outputs the signal, as shown in FIG. 5. Simulation cannot handle analog signals, and a simulation model of a temperature sensor macro would be such a model as shown in FIG. 6 (the simulation model 9).

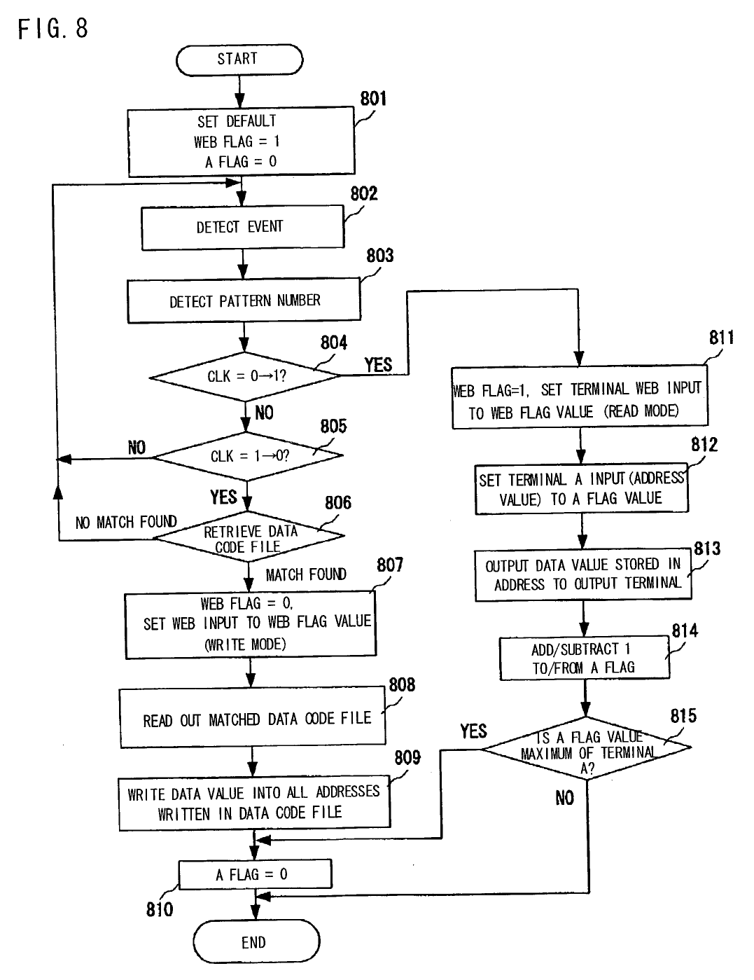

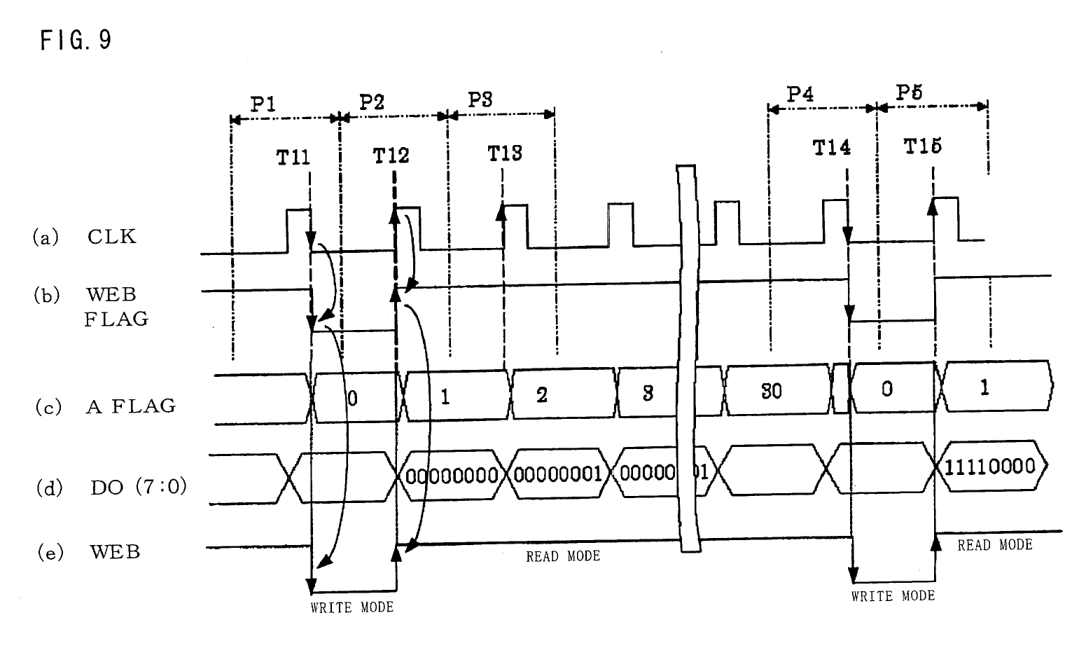

Then, a theoretical simulation model of the temperature sensor macro is designed, and its internal node has the memory macro model 9-1 shown in FIG. 7. The simulation is carried out with the memory macro model 9-1. The logic simulation with the memory macro model 9-1 will be explained hereinafter with reference to the flowchart shown in FIG. 8 and the timing chart shown in FIG. 9.

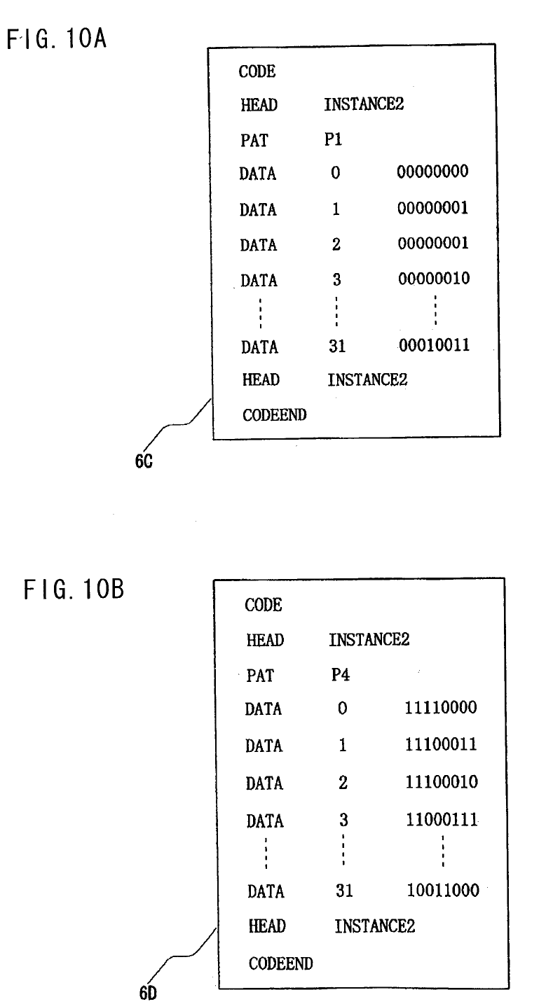

In this logic simulation, the clock signal shown in FIG. 9(a) is given to the clock input terminal CLK as a verification pattern. The data code files 6C and 6D shown in FIGS. 10A and 10B are used as the data code file 6. In the data code files 6C and 6D, an instance name of the memory macro model using the data code file is written on the HEAD line, the verification pattern number on the PAT line, and an address value (the first argument) and a data value (the second argument) on the DATA line. The pattern number is counted based on each system clock cycle after the logic simulation has started: the first pattern in the first clock cycle, the second pattern in the second clock cycle, and so on.

Logic Simulation with Memory Macro Model

At the start of logic simulation with the memory macro model 9-1, the logic simulation unit 7 initializes the WEB flag to “1”, and the A flag to “0” (Step 801). The WEB flag and A flag are initialized only at the beginning of the logic simulation execution, and not at logical operations performed repeatedly during the logic simulation execution. It is to be noted that the WEB flag and the A flag are provided in the logic simulator 7.

Batch-Writing of Data

The logic simulation unit 7 detects an input event at Step 802. When a clock signal to the clock input terminal CLK changes from level 1 to 0 at T11 in FIG. 9(a), the verification pattern number is detected at the same time (Step 803). The pattern number “P1” is detected in this case.

The logic simulation unit 7 identifies that the clock signal does not change from “0 to “1” (NO at Step 804), but changes from “1” to “0” (YES at Step 805), and then, searches a data code file (Step 806).

In the data code file search, the logic simulation unit 7 retrieves from directories the data code file whose instance name written on the HEAD line thereof matches the instance name of the memory macro model 9-1, and a pattern number written on the PAT line thereof matches the pattern number extracted at Step 803.

Since the instance name of the memory macro model 9-1 is “INSTANCE 2”, and the pattern number extracted at Step 803 is “P1”, the data code file 6C shown in FIG. 10A is selected. Then, the logic simulation unit 7 sets the WEB flag to “0” (T11 at FIG. 9(b)), and sets a value of the mode switching signal to the mode switching terminal WEB to the same value as the WEB flag value (T11 at FIG. 9(e)), to change modes of the memory macro model 9-1 to the write mode (Step 807).

Then, the logic simulation unit 7 reads out the data code file 6C selected at Step 806 (Step 808), and writes the data at once to the memory macro model 9-1, according to contents of the data code file 6C which are addresses and data to be written to the addresses (Step 809). After the batch data writing, the A flag is set back to “0” for the subsequent logical operation.

Data Readout

When a clock signal to the clock input terminal CLK changes from level 0 to 1 at T12 in FIG. 9(a), the verification pattern number is detected at the same time (Step 803). The pattern number “P2” is detected in this case.

Then, the logic simulation unit 7 identifies that the clock signal changes from level 0 to 1 (YES at Step 804) to proceed to Step 811. Step 811 sets the WEB flag to “1” (T12 in at FIG. 9(b)), and sets a value of a mode switching signal to the mode switching terminal WEB to the same value as the WEB flag value (T12 at FIG. 9(e)). The memory macro model 9-1 thereby turns to the read mode.

Then, a signal value to the address input terminal A is set to the value of A flag, which is “0” in this case (Step 812), and the address value “0” is extracted from the signal value. The data value stored in the extracted address “0” is read out from the memory macro model 9-1 and output to the data output terminal DO (Step 813).

After the data output, “1” is added to the A flag (Step 814), and the A flag value is checked if it is a maximum value of the address input terminal A, which is “32” in the present embodiment having 5 bit (4 to 0), or not (Step 815). If it is not the maximum value, the logic simulation unit 7 sets for the subsequent logical operation. If, on the other hand, it is the maximum value, the logic simulation unit 7 sets the A flag to “0”, and sets for the subsequent logical operation

At T13, as well as at T12, the WEB flag is set to “1” (Step 811), an address value to the terminal A is set to the A flag Value “1” (Step 812). The data value stored in the address “1” is then read out from the memory macro model 9-1 and output to the data output terminal DO (Step 813). Data stored in the addresses “0” to “31” of the memory macro model 9-1 are output to the data output terminal DO in the same manner.

After the WEB flag has changed to “1” at T12, the process does not proceeds to Step 807 and the WEB flag does not change to “0” until the data code file in which the pattern number extracted at Step 803 is written on the PAT line is found at Step 806.

When the clock signal to the clock input terminal CLK changes from level 1 to 0 at T14, the process proceeds through NO at Step 804 and YES at Step 805 to Step 806 and searches a data code file. Step 803 detects the verification pattern number “P4” in this case, which matches the pattern number written on the PAT line of the data code file 6D shown in FIG. 10B.

The logic simulation unit 7 therefore sets the WEB flag to “0” (T14 at FIG. 9(b)), and sets a value of the mode switching signal to the mode switching terminal WEB to the value of the WEB flag (T14 at FIG. 9(e)). The memory macro model 9-1 thereby turns to the write mode (Step 807).

Then, the logic simulation unit 7 reads out the data code file 6D selected at Step 806 (Step 808), and writes the data at once to the memory macro model 9-1, according to contents of the data code file 6D which are addresses and data to be written to the addresses (Step 809). The logic simulation unit 7 then sets the A flag back to “0” for the subsequent logical operation.

Since the clock input terminal CLK changes from level 0 to 1 at T15, the process proceeds through YES at Step 804 to Step 811 to set the WEB flag to 1 to perform logical operation in the read mode.

The data code files 6C and 6D used in the second embodiment store output signal values of a sequence of temperature changes in the addresses. Therefore, the use of many more data code files of this kind allows description of various temperature changes.

In the above process, system operation under varied temperatures can be verified in one-time logic simulation. For example, it is possible to verify the operation detecting increase of temperature and interrupting processing in a system, the operation detecting decrease of temperature and changing modes of the system into a low power consumption mode, and the like.

Third Embodiment

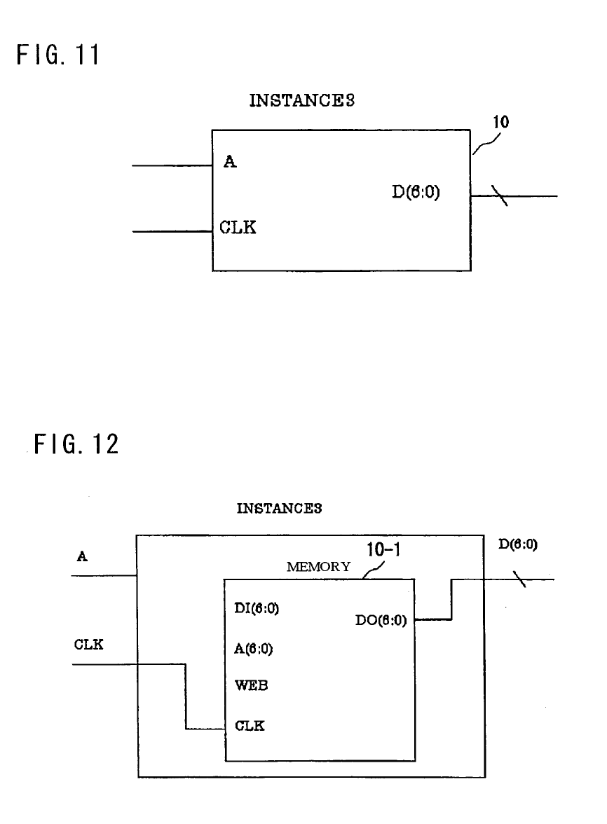

The third embodiment explains a case of simulating an A/D converter macro converting analog signals into digital signals. As shown in FIG. 11, the simulation model 10 of an A/D converter macro is provided with an analog signal input terminal A, a clock input terminal CLK, and a digital output terminal D.

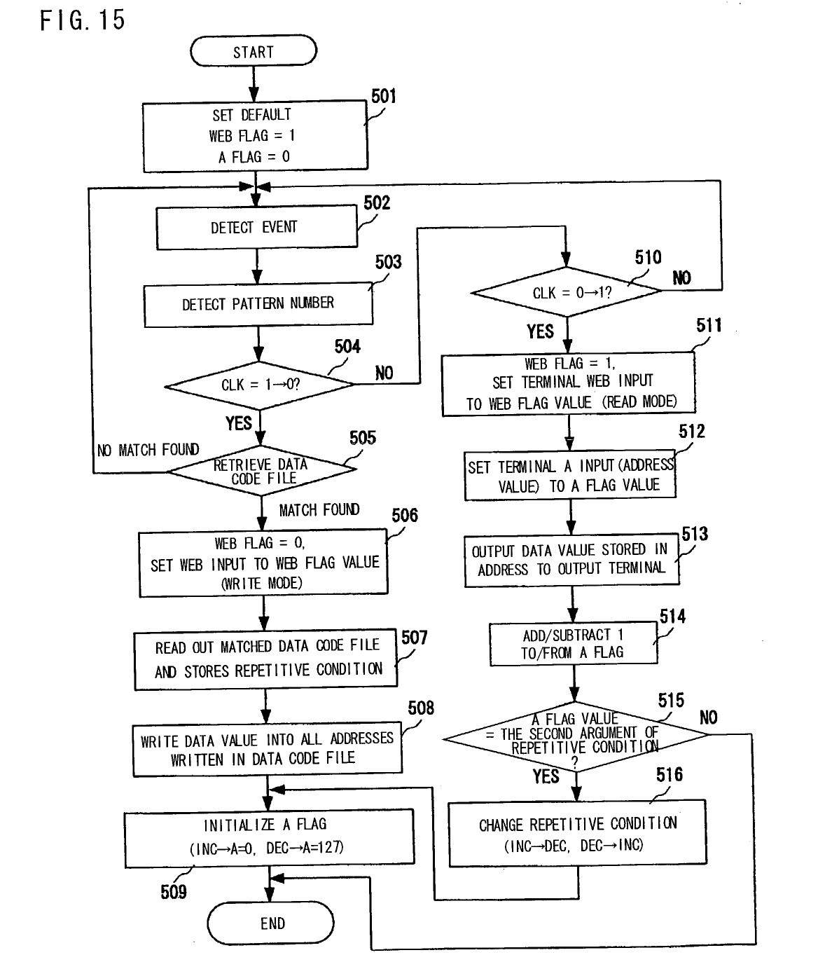

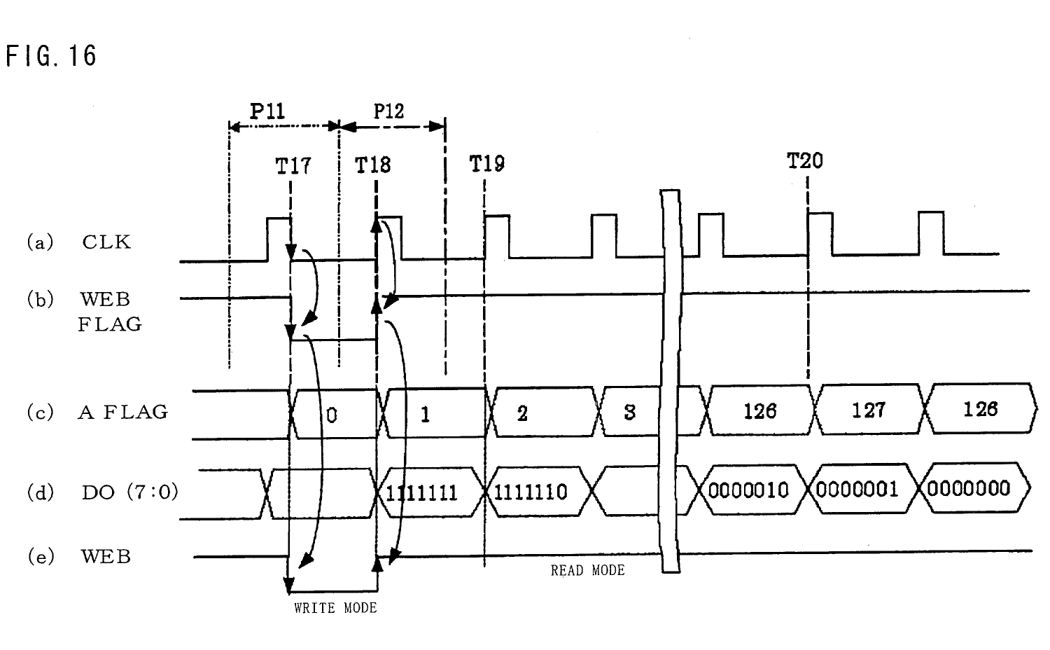

Since a logic simulation cannot handle analog signals, a theoretical simulation model of an A/D converter macro is designed. Its internal node has the memory macro model 10-1 as show in FIG. 12. The logic simulation with the memory macro model 10-1 will be explained hereinafter with reference to the flowchart shown in FIG. 15 and the timing chart shown in FIG. 16.

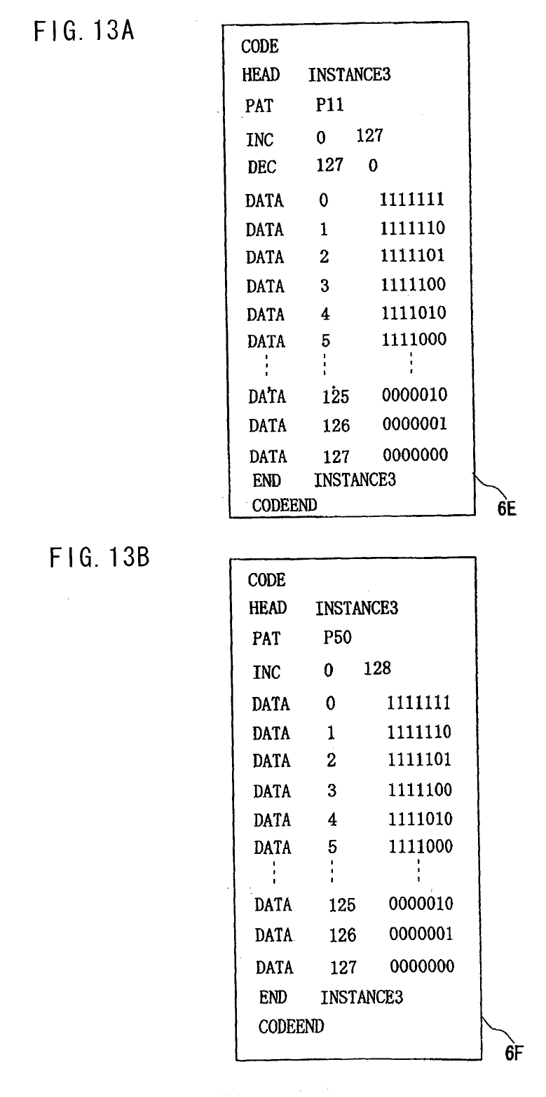

In this logic simulation, the clock signal shown in FIG. 16(a) is given to the clock input terminal CLK as a verification pattern. The data code files 6E and 6F shown in FIGS. 13A and 13B are used as a data code file 6.

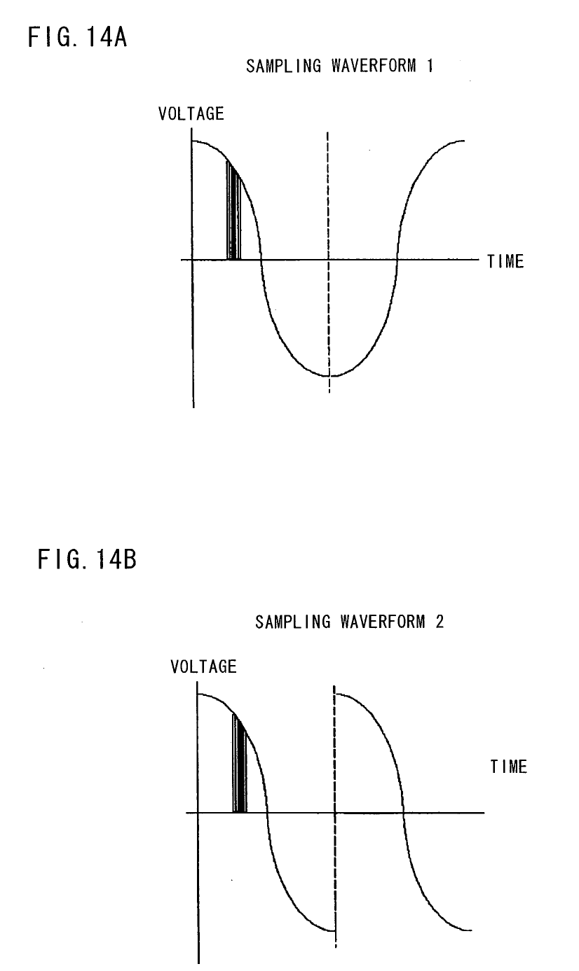

When the A/D converter macro converts a sine wave analog signal as shown in FIG. 14A into a digital signal, half-waveperiod of the sine wave is divided up into 128 sampling points, and the voltage range is divided up into 128 levels for sampling. The sampled values are used to form the data code files 6E and 6F. The data code files 6E and 6F have 128 lines of DATA lines, in the first and second arguments of which are written the sampling point number and the sampled value in bit, respectively. Analog signal sampling is possible in a saw wave as well.

On the PAT line of the data code file is written the verification pattern number. There are provided a INC line and DEC line, on which increment condition and decrement condition are written respectively as repeating condition. In the first and second argument on the INC line are written an address value to start increment and an address value to stop increment, respectively, and an address value is incremented one by one according thereto. In the first and second argument on the DEC line are written an address value to start decrement and an address value to stop decrement, respectively, and an address value is decremented one by one according thereto.

Logic Simulation with Memory Macro Model

At the start of logic simulation with the memory macro model 10-1, the logic simulation unit 7 initializes the WEB flag to “1”, and the A flag to “0” (Step 501). The WEB flag and A flag are initialized only at the beginning of the logic simulation with the memory macro model 10-1, and not at logical operations performed repeatedly during the logic simulation.

Batch-Writing of Data

The logic simulation unit 7 detects an input event at Step 502. When a clock signal to the clock input terminal CLK changes from level 1 to 0 at T17 in FIG. 16(a), the verification pattern number is detected at the same time (Step 503). The pattern number is “P11” in this case.

Then, the logic simulation unit 7 confirms that the clock signal to the clock input terminal CLK has changed from level 1 to 0 (YES at Step 504), and searches a data code file (Step 505). In the data code file search, the logic simulation unit 7 retrieves from directories such a data code file that an instance name written on the HEAD line thereof matches the instance name of the memory macro model 10-1, and a pattern number written on the PAT line thereof matches the pattern number extracted at Step 503.

Since the instance name of the memory macro model 10-1 is “INSTANCE 3”, and the pattern number extracted at Step 503 is “P11”, the data code file 6E shown in FIG. 13A is selected. Then, the logic simulation unit 7 sets the WEB flag to “0” (T17 at FIG. 16(b)), and sets a value of a mode switching signal to the mode switching terminal WEB to the same value as the WEB flag value (T17 at FIG. 16(e)). The memory macro model 10-1 thereby turns to the write mode (Step 506).

The logic simulation unit 7 reads out the data code file 6E selected at Step 505 and stores the repeating condition (increment condition) written on the INC line of the data code file 6E (Step 507). Then, data are written at once to the memory macro model 10-1, according to contents of the data code file 6E which are addresses and data to be written to the addresses (Step 508). The first argument value “0” written on the INC line is substituted to the A flag (Step 509) for the subsequent logical operation.

Data Readout

When a clock signal to the clock input terminal CLK changes from level 0 to 1 at T18 in FIG. 16, the verification pattern number at the time of the change is detected (Step 503). The detected pattern number is “P12” in this case.

Then, the logic simulation unit 7 identifies that the clock signal changes from level 0 to 1 (YES at Step 510) to proceed to Step 511. Step 511 sets the WEB flag to “1” (T18 in at FIG. 16(b)), and sets a value of a mode switching signal to the mode switching terminal WEB to the same value as the WEB flag value (T18 at FIG. 16(e)). The memory macro model 10-1 thereby turns to the read mode.

Then, a signal value to the address input terminal A is set to the value of the A flag, which is “0” in this case (Step 512), and the address value “0” is extracted from the signal value. The data value stored in the extracted address “0” is read out from the memory macro model 10-1 and output to the data output terminal DO (Step 513).

After the data output, “1” is added to the A flag according to the increment condition stored at Step 507 (Step 514). The A flag value is then checked if it is the same as the second argument of the increment condition stored at Step 507 (Step 515). If it is not the same value, the logic simulation unit 7 sets for the subsequent logical operation.

Steps 510 to 515 are repeated hereinafter every time the clock signal changes from level 0 to 1. The data stored in the address “0” to “127” are thereby read out in order and output to the data output terminal DO.

If, at Step 515, the A flag value is the same as the second argument of the increment condition stored at Step 507, that is, if the A flag value is “127”, the logic simulation unit 7 changes the repeating condition stored therein (Step 516). In this case, the unit 7 stores the decrement condition written on the DEC line of the data code file 6E selected at Step 505. Then, the unit 7 substitutes the first argument value “127” written on the DEC line to the A flag (Step 509), and sets for the subsequent logical operation.

Steps 510 to 515 are repeated hereinbelow at every change of the clock signal from level 0 to 1 to read out the data stored in the address “127” to “0” in order, and output the data to the data output terminal DO. In this case, Step 514 subtracts “1” from the A flag value. The sampling waveform 1 shown in FIG. 14A is thereby output from the data output terminal DO of the memory macro model 10-1.

The explanation above is given on the case where the data code file 6E shown in FIG. 13A is selected at Step 505. If the data code file 6F is selected, on the other hand, the addresses and data stored in the data code file 6F are written at once to the memory macro model 10-1, and the data written to the memory macro model 10-1 are then read out according to the repeating condition written in the data code file 6F.

Since the data code file 6F does not include a DEC line, that is, only increment condition is written therein, conditions do not change at Step 516, and the increment condition remains active as a repeating condition. In this case, Step 509 sets the A flag to “0” and restart data readout from the address “0”. The sampling waveform 2 shown in FIG. 14B is thereby output from the data output terminal DO of the memory macro model 10-1.

The data code file used in the third embodiment stores signal values sampled from analog signals in each address thereof. Therefore, a plurality of data code files allow various analog signal changes to be described. Further, various waveforms can be formed by specifying repeating condition of address.

Although the above first to third embodiments have explained the case where the present invention is applied to gate-level logic simulation, the present invention is also applicable to logic simulation of register transfer logic (RTL) level.

Also, in terms of achieving a particular function with a normal function of a logic simulation model as a key function, the present invention is not restricted to the particular function of batch writing of memory macro data, whereas the present invention also allows batch setting of default values of internal node of a system on chip (SOC) macro including a memory macro.

As explained in the foregoing, the present invention extracts a search key (for example, an address and data, or a verification pattern number) from a verification pattern at write-in operation in the first clock cycle after turning to a data write mode, retrieves a necessary data code file specified by the extracted search key from a plurality of data code files, and writes data to the simulation model of the memory macro at once according to contents of the retrieved data code file. The present invention thereby saves time for logic simulation execution and verification pattern creation without a virtual terminal or internal node.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A logic simulation method for a simulation model including a memory macro, comprising steps of:
preparing a plurality of data code files, each of said data code files including a plurality of data;
setting the simulation model of the memory macro with a search key;
selecting one of the plurality of data code files, which is identified by the search key; and
writing the data of said one of the plurality of data code files at once into the memory macro.

2. A logic simulation method according to claim 1, wherein the search key is determined based on a verification pattern at the write-in operation in a first clock cycle after a data write mode has been set into the memory macro.

3. A logic simulation method according to claim 2, wherein the search key includes an address and data extracted from the verification pattern.

4. A logic simulation method according to claim 1, wherein the search key includes a pattern number.

5. A logic simulation method according to claim 1, wherein each of the data code files further includes a plurality of addresses each associated with one of said data.

6. A computer program product, in a computer-readable medium, for performing a simulation on a simulation model including a memory macro and a plurality of data code files each having a plurality of data, the computer program product comprising:
instructions for setting the simulation model of the memory macro with a search key;
instructions for selecting a data code file from the plurality of data code files, based on the search key; and
instructions for writing data at once to the simulation model of the memory macro according to contents of the selected one of the data code files.

7. A computer program product according to claim 6, wherein the search key is determined based on a verification pattern at the write-in operation in a first clock cycle after a data write mode has been set into a the memory macro.

8. A computer program product according to claim 6, wherein the search key includes an address and data accompanied with the address.

9. A computer program product according to claim 6, wherein the search key includes a pattern number of when the memory macro is brought into a data wirte operation mode.

10. A computer program product according to claim 6, wherein the data written at once include data stored in the data code file in association with each of a plurality of addresses.

11. A method for performing logic simulation on a simulation model that has a memory macro and a data processing circuit coupled to receive and manipulates data read out from said memory macro, comprising:
writing a plurality of data into said memory macro at one time;
reading out said plurality of date from said memory macro in sequence; and
supplying said data processing circuit with said plurality of data read out in sequence from said memory macro.

12. The method as claimed in claim 11, further comprising:
preparing a plurality of data code files, each of said data code files including a plurality of data;
providing information to bring said memory macro into a data write operation mode; and
identifying, in response to said information, one of said data code files,
said wiring a plurality data into said memory macro at one time being executed when one of said data code files is identified.

13. The method as claimed in claim 12, wherein said information comprising a search key, said data code files including respectively unique search keys to be differentiated from one another, one of said data code files being identified when said search key of said information is identical with the unique search key of said one of said data code files.

14. The method as claimed in claim 11, wherein said circuit comprises a analog macro generating a plurality of digital codes in response to an analog signal supplied thereto, said memory macro being used in place of said analog macro so that said plurality of digital codes are written into said memory macro at one time.

15. The method as claimed in claim 14, wherein said analog macro comprises a temperature sensor macro.

16. The method as claimed in claim 14, wherein said analog macro comprises an analog-to-digital converter macro.
